(19) United States
(12) Patent Application Publication
(10) Pub. No.: US 2025/0008070 A1
(43) Pub. Date: Jan. 2, 2025

(54) IMAGING DEVICE AND PARALLAX DEVIATION CORRECTION METHOD

(71) Applicant: Hitachi Astemo, Ltd., Hitachinaka-shi, Ibaraki (JP)

(72) Inventors: Naoya TADA, Hitachinaka-shi, Ibaraki (JP); Maho HORINAGA, Hitachinaka-shi, Ibaraki (JP); Yuji OTSUKA, Hitachinaka-shi, Ibaraki (JP)

(73) Assignee: Hitachi Astemo, Ltd., Hitachinaka-shi, Ibaraki (JP)

(21) Appl. No.: 18/697,808

(22) PCT Filed: Aug. 23, 2022
(86) PCT No.: PCT/JP2022/031763

§ 371 Date: Apr. 2, 2024

(30) Foreign Application Priority Data
Oct. 5, 2021 (JP) 2021-164217

(51) Int. Cl. H04N 13/246; G06T 7/80; H04N 13/239

(52) U.S. Cl. CPC H04N 13/246; G06T 7/85; H04N 13/239

(57) ABSTRACT

An imaging device 10 includes a first imaging unit 11 and a second imaging unit 12 disposed at positions separated by a constant distance, a first parallax calculator 13 that calculates a first parallax based on an image of a first pattern 21 captured by the first imaging unit 11 and an image of the first pattern 21 captured by the second imaging unit 12, a second parallax calculator 14 that calculates a second parallax based on the image of the first pattern 21 captured by the first imaging unit 11 and an image of a second pattern 22 captured by the second imaging unit 12, and a correction unit 15 that corrects a parallax deviation between the first imaging unit 11 and the second imaging unit 12 based on the first parallax and the second parallax.

### TECHNICAL FIELD

The present invention relates to an imaging device and a parallax deviation correction method.

The present application claims the priority based on Japanese Patent Application No. 2021-164217, filed on Oct. 5, 2021, the content of which is incorporated herein.

### BACKGROUND ART

For an imaging device, there has been known, for example, an in-vehicle stereo camera mounted on a vehicle. The in-vehicle stereo camera is used widely for driver assistance systems, such as collision damage mitigation brake functions, as the in-vehicle stereo camera allows processing images by calibration parameters corresponding thereto, obtaining parallax images, and measuring a distance to a photographic subject using the obtained parallax images.

The in-vehicle stereo camera is installed inside a vehicle interior so as to allow capturing the surrounding area of the vehicle through a windshield, and therefore, parallax deviates by an effect of a windshield distortion. When this parallax deviation is present, the distance to the photographic subject fails to be accurately measured to possibly cause an incorrect operation of the driver assistance system. In view of this, it is necessary to calibrate an optical axis (in other words, correct the parallax deviation) after the stereo camera is mounted on the vehicle, in order to generate an accurate parallax image. The calibration is roughly divided into two types, and one is the calibration performed in a static environment with a chart installed ahead of the stereo camera. The other is the calibration performed in a dynamic environment, for example, while driving on a public road.

The calibration performed in a static environment is to, by installing the chart ahead of the vehicle (that is, ahead of the stereo camera), correct a difference between an ideal value of the parallax calculated from the installation distance of the chart and a value of the parallax image captured by the stereo camera, which obtains a correct parallax value. For a technique regarding it, for example, Patent Literature 1 discloses a method for properly correcting a parallax deviation due to a windshield distortion by comparing images in which the chart disposed ahead of the vehicle is captured with the windshield and without the windshield.

### CITATION LIST

### Patent Literature

Patent Literature 1: JP 2015-169583 A

### SUMMARY OF INVENTION

### Technical Problem

However, when there is an error in installation distance of the chart (that is, a distance from the stereo camera to the chart) (in other words, when there is an installation deviation of the chart), there occurs a problem that the parallax deviation is no longer properly correctable with the above-described correction method.

The present invention has been made in order to solve such a technical problem, and an objective of the present invention is to provide an imaging device and a parallax deviation correction method configured to properly correct a parallax deviation even when there is an installation deviation of a chart.

### Solution to Problem

An imaging device according to the present invention is disposed at a known distance and corrects a parallax deviation by capturing a chart having a first pattern and a second pattern. The imaging device includes a first imaging unit, a second imaging unit, a first parallax calculator, a second parallax calculator, and a correction unit. The second imaging unit is disposed at a position separated by a constant distance from the first imaging unit. The first parallax calculator calculates a first parallax based on the image of the first pattern captured by the first imaging unit and an image of the first pattern captured by the second imaging unit. The second parallax calculator calculates a second parallax based on an image of the first pattern captured by the first imaging unit and an image of the second pattern captured by the second imaging unit. The correction unit corrects a parallax deviation between the first imaging unit and the second imaging unit based on the first parallax calculated by the first parallax calculator and the second parallax calculated by the second parallax calculator.

With the imaging device according to the present invention, the correction unit corrects the parallax deviation between the first imaging unit and the second imaging unit based on the first parallax calculated by the first parallax calculator and the second parallax calculated by the second parallax calculator, and therefore, even when there is an installation deviation of the chart, the parallax deviation is correctable without being affected by the installation deviation of the chart. As the result, even when there is an installation deviation of the chart, the parallax deviation is properly correctable.

### Advantageous Effects of Invention

With the present invention, even when there is an installation deviation of the chart, the parallax deviation is properly correctable.

### BRIEF DESCRIPTION OF DRAWINGS

FIG. 1 is a drawing for describing a ranging principle of a stereo camera.

FIG. 2 is a block diagram illustrating an imaging device according to an embodiment.

FIG. 3 is a drawing illustrating an exemplary chart used in correcting a parallax deviation.

FIG. 4 is a flowchart illustrating a parallax deviation correction method using the imaging device.

FIG. 5 is a conceptual drawing for describing a calculation of a first parallax.

FIG. 6 is a conceptual drawing for describing a calculation of a second parallax.

FIG. 7 is a drawing illustrating a relation between a parallax deviation amount and an installation deviation amount of the chart.

### DESCRIPTION OF EMBODIMENTS

The following describes an embodiment of an imaging device and a parallax deviation correction method according to the present invention with reference to the drawings. In the following description, right and left directions and positions, and a horizontal direction and a horizontal position are seen from a vehicle on which the imaging device is mounted.

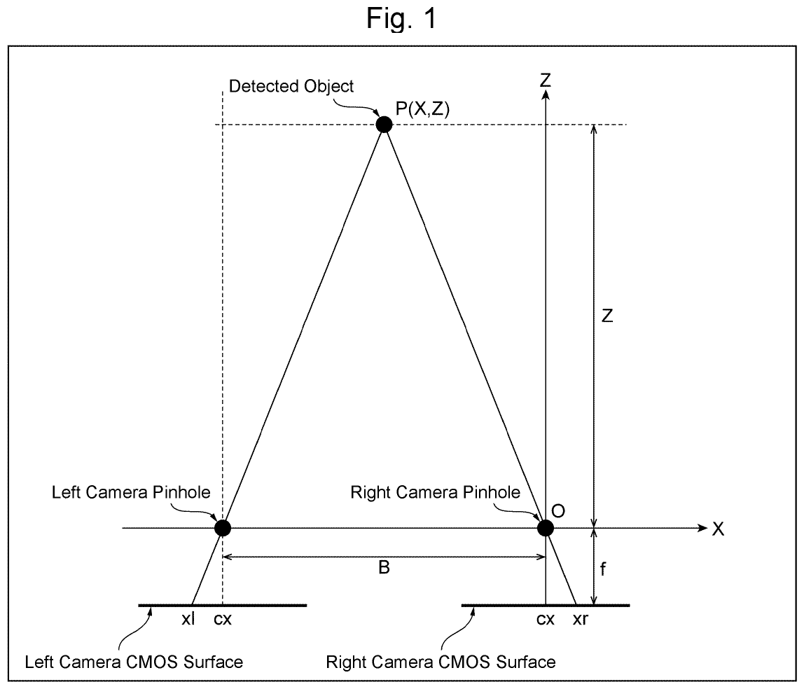

An imaging device 10 of the embodiment includes, for example, a stereo camera disposed inside a vehicle interior of an automobile, and is a device for capturing a recognized object ahead of the vehicle through a windshield with a pair of right and left cameras disposed keeping a constant distance therebetween, and measuring a distance to the recognized object based on captured images. A description will be given of a ranging principle of the stereo camera based on FIG. 1 here.

As illustrated in FIG. 1, when a distance (what is called, a baseline length) between the pair of right and left cameras constituting the stereo camera is B (mm), a focal distance of lenses of the pair of right and left cameras is f (mm), a pixel pitch of an image sensor (for example, a CMOS image sensor) is δ (mm/pixel), each horizontal position of captured image centers is cx (pixel), and horizontal positions when the recognized object (that is, a photographic subject) P (X, Z) ahead of the cameras is projected on respective CMOS surfaces of the pair of cameras are xl (pixel), xr (pixel), xl and xr are respectively representable by the following formulae.

$$\begin{matrix}[ Math . 1 ] & \\ xr = \frac{X * f}{Z * δ} + cx & ( 1 )\end{matrix}$$

$$xl = \frac{( X + B ) * f}{Z * δ} + cx \qquad ( 2 )$$

A difference between the right and left projection positions (xl−xr) is referred to as a parallax d (pixel). Accordingly, the parallax d is obtainable by the following formula (3).

$$\begin{matrix}[ Math . 2 ] & \\ d = xl - x r = \frac{B * f}{Z * δ} & ( 3 )\end{matrix}$$

A distance Z (mm) to a recognized object P is calculatable by the following formula (4).

$$\begin{matrix}[ Math . 3 ] & \\ Z = \frac{B * f}{d * δ} & ( 4 )\end{matrix}$$

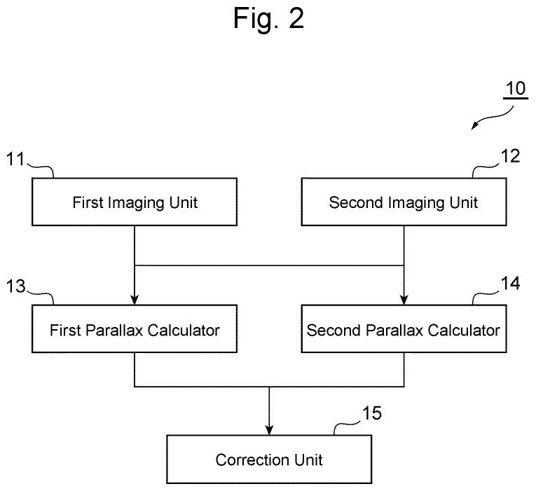

FIG. 2 is a block diagram illustrating the imaging device according to the embodiment. The imaging device 10 of the embodiment includes a pair of right and left imaging units (a first imaging unit 11 and a second imaging unit 12), a first parallax calculator 13, a second parallax calculator 14, and a correction unit 15. The first imaging unit 11 and the second imaging unit 12 are disposed separated by a distance of the baseline length in the horizontal direction, and are each constituted of an image sensor, such as a CMOS image sensor.

The first parallax calculator 13 calculates a first parallax based on an image captured by the first imaging unit 11 and an image captured by the second imaging unit. Specifically, the first parallax calculator 13 uses the image captured by the first imaging unit 11 as a standard image, and extracts feature points having changing gray-scale. Next, the first parallax calculator 13, while using the image captured by the second imaging unit 12, which is the other imaging unit, as a reference image, searches for a position at which the same photographic subject appears on the reference image with respect to the extracted feature points. For the searching, for example, template matching, such as Sum of Absolute Difference (SAD), may be used. The first parallax calculator 13 calculates a difference between the extracted feature points and the position where the same photographic subject appears on the reference image as a first parallax.

The second parallax calculator 14 calculates a second parallax based on the image captured by the first imaging unit 11 and the image captured by the second imaging unit 12. Specifically, the second parallax calculator 14 uses the image captured by the first imaging unit 11 as a standard image, and extracts feature points having changing gray-scale shading transitions. Next, the second parallax calculator 14, while using the image captured by the second imaging unit 12, which is the other imaging unit, as a reference image, searches for a position at which, for example, a photographic subject at another position having the same pattern appears on the reference image with respect to the extracted feature points. For the searching, for example, template matching, such as SAD, may be used. The second parallax calculator 14 calculates a difference between the extracted feature points and the position where the photographic subject appears on the reference image as a second parallax.

The correction unit 15 corrects a parallax deviation between the first imaging unit 11 and the second imaging unit 12 based on the first parallax calculated by the first parallax calculator 13 and the second parallax calculated by the second parallax calculator 14.

The imaging device 10 having the structure captures a chart that is disposed at a known distance and has a first pattern and a second pattern using the first imaging unit 11 and the second imaging unit 12, and corrects a parallax deviation between the first imaging unit 11 and the second imaging unit 12 in a baseline length direction (that is, a right-left direction) based on the captured images.

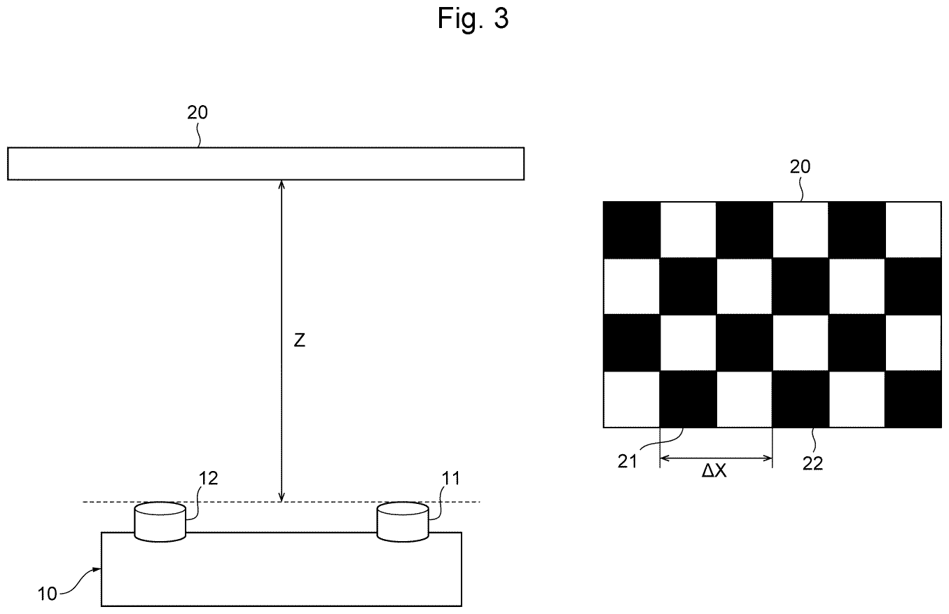

FIG. 3 is a drawing illustrating an exemplary chart used in correction of a parallax deviation. In FIG. 3, the left side is a plan view of the chart, and the right side is a front view of the chart. As illustrated in FIG. 3, a chart 20 is, for example, a flat plate having a constant thickness, and is installed at a position separated away from the imaging device 10 by the known distance Z. When there is no installation deviation of the chart 20, the installation distance (that is, the distance from the imaging device 10 to the chart 20) of the chart 20 to the imaging device 10 is equal to the known distance Z.

The chart 20 has a main surface facing the imaging device 10 on which a predetermined pattern (here, a checkered pattern) is provided. Here, adjacent black squares are set as a first pattern 21 and a second pattern 22, respectively, and a distance between the first pattern 21 and the second pattern 22 in the horizontal direction is set as ΔX. Note that the pattern provided on the chart 20 is not limited to a checkered pattern, and may, for example, be a circular shape, as long as the feature points are detectable.

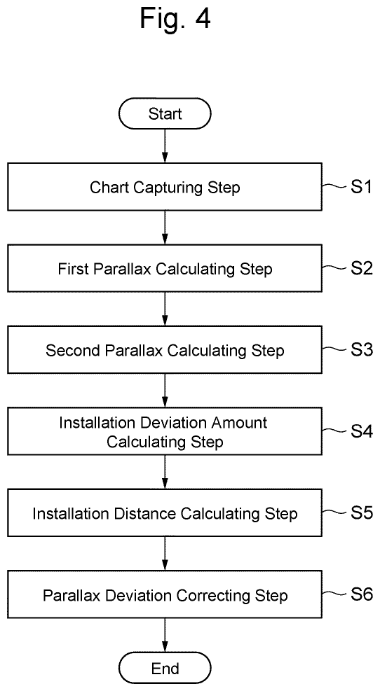

The following describes a parallax deviation correction method using the imaging device 10 based on FIG. 4. The parallax deviation correction method of the embodiment includes a chart capturing step S1, a first parallax calculating step S2, a second parallax calculating step S3, an installation deviation amount calculating step S4, an installation distance calculating step S5, and a parallax deviation correcting step S6. Note that the installation deviation amount calculating step S4, the installation distance calculating step S5, and the parallax deviation correcting step S6 constitute a “correction step” as recited in the claims.

In the chart capturing step S1, the first imaging unit 11 and the second imaging unit 12 capture the chart 20 installed ahead of the imaging device 10.

In the first parallax calculating step S2, the first parallax calculator 13 calculates a first parallax based on an image of the first pattern 21 captured by the first imaging unit 11 and an image of the first pattern 21 captured by the second imaging unit 12.

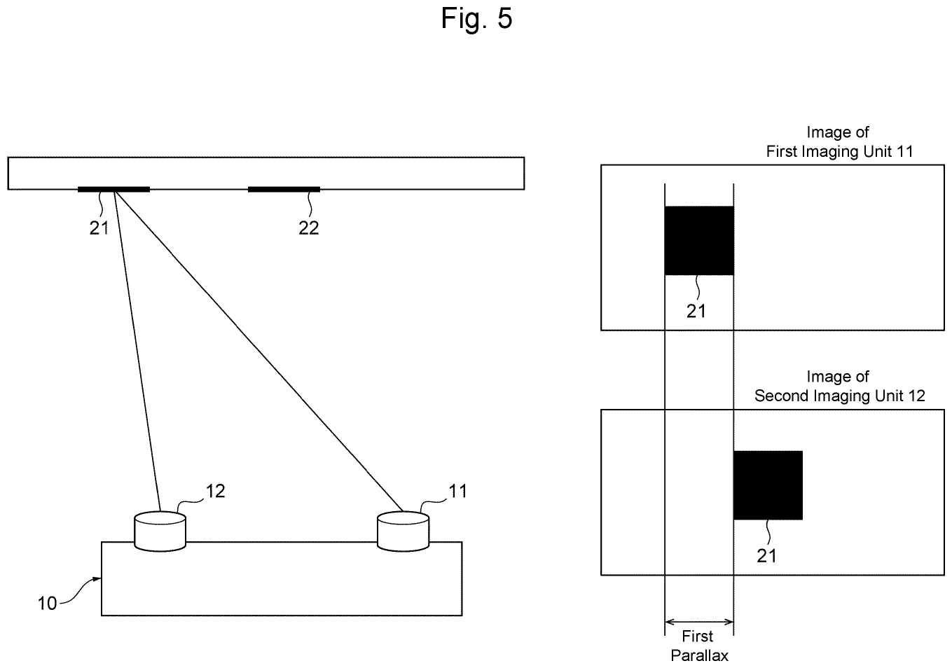

At this time, the first parallax calculator 13 uses the image of the first pattern 21 captured by the first imaging unit 11 as a standard image and the image of the first pattern 21 captured by the second imaging unit 12 as a reference image, to calculate the first parallax by template matching. Specifically, the first parallax calculator 13 calculates, as illustrated in FIG. 5, a difference between a position of the first pattern 21 on the image captured by the first imaging unit 11 and a position of the first pattern 21 on the image captured by the second imaging unit 12 in the baseline length direction (that is, the right-left direction) as the first parallax.

In the second parallax calculating step S3, the second parallax calculator 14 calculates a second parallax based on the image of the first pattern 21 captured by the first imaging unit 11 and an image of the second pattern 22 captured by the second imaging unit 12. That is, the second parallax calculator 14 uses the captured images of different patterns for calculating the parallax, unlike the first parallax calculator 13.

As illustrated in FIG. 3, since the first pattern 21 and the second pattern 22 are in the same pattern, the second parallax calculator 14, at this time, uses the image of the first pattern 21 captured by the first imaging unit 11 as a standard image and the image of the second pattern 22 captured by the second imaging unit 12 as a reference image, to calculate the second parallax by template matching.

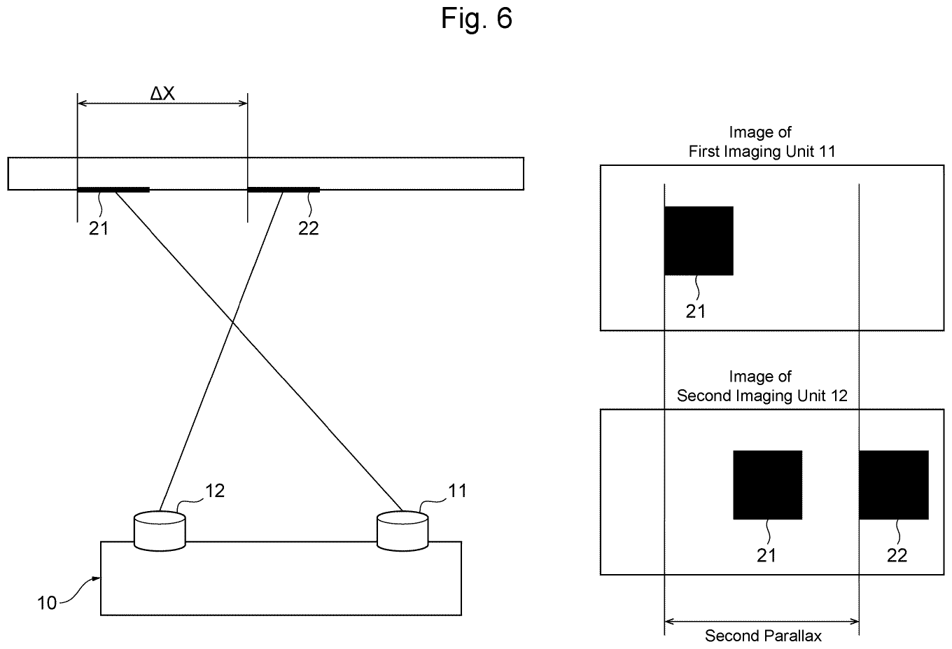

Specifically, as illustrated in FIG. 6, the second parallax calculator 14 calculates a difference between a position of the first pattern 21 on the image captured by the first imaging unit 11 and a position of the second pattern 22 on the image captured by the second imaging unit 12 in the baseline length direction (that is, the right-left direction) as the second parallax. When the second parallax is calculated, the above-described formula (2) becomes the formula (5), and the above-described formula (3) becomes a formula (6). From the formula (6), it is seen that the second parallax is a parallax of the baseline length (B+ΔX) (in other words, a parallax when the baseline length is deviated by ΔX).

$$\begin{matrix}[ Math . 4 ] & \\ xl = \frac{( X + B + Δ X ) * f}{Z * δ} + cx & ( 5 )\end{matrix}$$

$$d = xl - xr = \frac{( B + Δ X ) * f}{Z * δ} \qquad ( 6 )$$

As described above, ΔX is a distance between the first pattern 21 and the second pattern 22 in the chart. Since the second parallax is calculated by template matching, a detection error occurs. From the perspective of reducing the effect of this detection error, the value of ΔX is larger the better.

In the installation deviation amount calculating step S4, the correction unit 15 calculates an installation deviation amount of the chart 20 using the first parallax and the second parallax. Regarding the above-described formula (3), for example, when an installation deviation amount ΔZ is generated in the installation distance of the chart 20, a parallax deviation amount Δd is generated as illustrated in a formula (7).

$$\begin{matrix}[ Math . 5 ] & \\ d + Δ d = \frac{B * f}{( Z * Δ Z ) * δ} & ( 7 )\end{matrix}$$

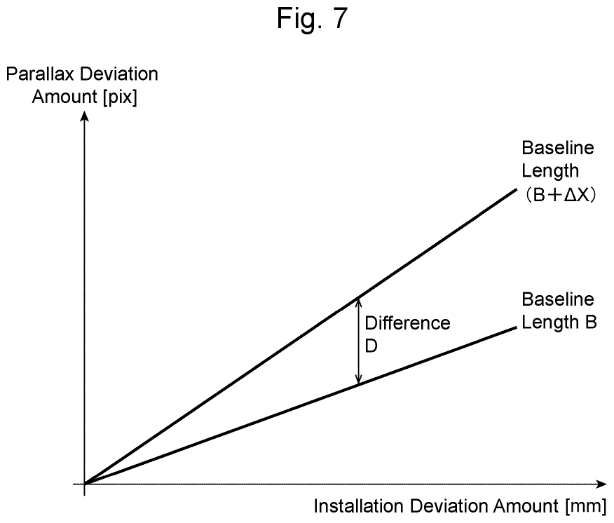

When the installation distance of the chart 20 is a constant value (for example, the known distance Z), a relation between the installation deviation amount (ΔZ) of the chart 20 and the parallax deviation amount (Δd) between the first imaging unit 11 and the second imaging unit 12 are as illustrated in FIG. 7. FIG. 7 is a drawing illustrating the relation between the parallax deviation amount and the installation deviation amount of the chart. In FIG. 7, the installation deviation amount of the chart 20 is on the horizontal axis, and the parallax deviation amount between the first imaging unit 11 and the second imaging unit 12 is on the vertical axis.

As illustrated in FIG. 7, when the installation deviation amount is the same, comparing the baseline length B and the baseline length (B+ΔX) shows that the parallax deviation amounts differ depending on the length of the baseline length. The difference D in FIG. 7 is generated by a difference between the baseline length (B+ΔX) and the baseline length B, and a magnitude of the value of the difference D is a different value for each installation deviation amount. Therefore, the difference D is calculated using the first parallax and the second parallax, and the installation deviation amount can be obtained based on the calculated difference D. When the installation distance of the chart 20 is determined to be a constant value (that is, the known distance), a conversion table or a first order approximation formula is preset such that the installation deviation amount becomes an output value with a value of the difference D being an input value, and thus, the installation deviation amount can be easily obtained.

The difference D is a difference between a parallax deviation amount when the baseline length is B (hereinafter simply referred to as a “parallax deviation amount of the baseline length B”) and a parallax deviation amount when the baseline length is (B+ΔX) (hereinafter simply referred to as a “parallax deviation amount of the baseline length (B+ΔX)”). The parallax deviation amount of the baseline length B is a difference between a parallax obtained by assigning the installation distance (the known distance) of the chart 20 in the formula (3) and the first parallax calculated in the step S2 (in other words, the first parallax calculated by the first parallax calculator 13 (see FIG. 5)). Meanwhile, the parallax deviation amount of the baseline length (B+ΔX) is a difference between a parallax obtained by assigning the installation distance (the known distance) of the chart 20 in the formula (6) and the second parallax calculated in the step S3 (in other words, the second parallax calculated by the second parallax calculator 14 (see FIG. 6)).

Once the difference D is known, as described above, the correction unit 15 uses the relation between the installation deviation amount and the parallax deviation amount illustrated in FIG. 7 or the preset conversion table or first order approximation formula based on the difference D to calculate the installation deviation amount of the chart 20.

In the installation distance calculating step S5, the correction unit 15 calculates the installation distance of the chart 20. Specifically, the correction unit 15 adds the installation deviation amount calculated in the step S4 to the installation distance (the known distance) of the chart 20 to calculate the installation distance of the chart 20.

In the parallax deviation correcting step S6, the correction unit 15, firstly, calculates an ideal parallax with the installation distance taking the installation deviation amount into account based on the installation distance of the chart 20 calculated in the step S5 and the above-described formula (4). Subsequently, the correction unit 15 calculates the parallax deviation amount between the first imaging unit 11 and the second imaging unit 12 based on the calculated ideal parallax and the first parallax calculated in the step S2. Subsequently, the correction unit 15 corrects the parallax deviation between the first imaging unit 11 and the second imaging unit 12 based on the calculated parallax deviation amount.

With the imaging device 10 of the embodiment, the correction unit 15 corrects the parallax deviation between the first imaging unit 11 and the second imaging unit 12 based on the first parallax calculated by the first parallax calculator 13 and the second parallax calculated by the second parallax calculator 14, and therefore, even when there is an installation deviation of the chart 20, the parallax deviation is correctable without being affected by the installation deviation of the chart 20. As the result, even when there is an installation deviation of the chart 20, the parallax deviation is properly correctable.

With the parallax deviation correction method using the imaging device 10, even when there is an installation deviation of the chart 20, the parallax deviation is properly correctable.

Note that, in the above-described step S3, while there has been described an example with the first pattern 21 and the second pattern 22 having the same pattern, the first pattern 21 and the second pattern 22 may have different patterns. When the first pattern 21 and the second pattern 22 have different patterns, the second parallax calculator 14, firstly, uses a template image of the first pattern 21 preliminarily prepared as a standard image and the image of the first pattern 21 captured by the first imaging unit 11 as a reference image, to detect a position (for example, a coordinate position) on the image of the first pattern 21 by template matching. Subsequently, the second parallax calculator 14 uses a template image of the second pattern 22 preliminarily prepared as a standard image and the image of the second pattern 22 captured by the second imaging unit 12 as a reference image to detect a position (for example, a coordinate position) on the image of the second pattern 22 by template matching. Subsequently, the second parallax calculator 14 calculates a difference between the detected position of the first pattern 21 on the image and the detected position of the second pattern 22 on the image as a second parallax. Accordingly, the second parallax is calculatable using the first pattern 21 and the second pattern 22 having different patterns.

In the above-described embodiment, while there has been described an example with the imaging device 10 being disposed inside the vehicle interior and capturing the chart 20 through the windshield, the imaging device 10 is applicable to the case where the chart 20 is captured without through a transparent body, such as a windshield.

In the above-described embodiment, the imaging device 10 may be constituted to further include a notification function for notifying an operator of the parallax deviation amount when the correction unit 15 calculates the parallax deviation amount between the first imaging unit 11 and the second imaging unit 12.

The embodiment of the present invention has been described in detail above, the present invention is not limited to the above-described embodiment, and is allowed to make various kinds of changes in design within the range not departing from the spirits of the present invention described in the appended claims.

### REFERENCE SIGNS LIST

10 Imaging device
11 First imaging unit
12 Second imaging unit
13 First parallax calculator
14 Second parallax calculator
15 Correction unit
20 Chart
21 First pattern
22 Second pattern

1. An imaging device that is disposed at a known distance and corrects a parallax deviation by capturing a chart having a first pattern and a second pattern, the imaging device comprising:
a first imaging unit;
a second imaging unit disposed at a position separated by a constant distance from the first imaging unit;
a first parallax calculator that calculates a first parallax based on an image of the first pattern captured by the first imaging unit and an image of the first pattern captured by the second imaging unit;
a second parallax calculator that calculates a second parallax based on an image of the first pattern captured by the first imaging unit and an image of the second pattern captured by the second imaging unit; and
a correction unit that corrects a parallax deviation between the first imaging unit and the second imaging unit based on the first parallax calculated by the first parallax calculator and the second parallax calculated by the second parallax calculator.

2. The imaging device according to claim 1,
wherein the correction unit calculates an installation deviation amount of the chart based on the first parallax calculated by the first parallax calculator, the second parallax calculated by the second parallax calculator, and a parallax calculated based on the known distance, calculates an installation distance of the chart based on the calculated installation deviation amount of the chart and the known distance, and corrects a parallax deviation between the first imaging unit and the second imaging unit based on the calculated installation distance of the chart.

3. The imaging device according to claim 2,
wherein the correction unit calculates a difference between parallax deviation amounts based on the first parallax calculated by the first parallax calculator, the second parallax calculated by the second parallax calculator, and the parallax calculated based on the known distance, and calculates an installation deviation amount of the chart based on a relation among the calculated difference between the parallax deviation amounts, a preset parallax deviation amount, and an installation deviation amount of the chart.

4. The imaging device according to claim 2,
wherein the correction unit calculates a parallax deviation amount between the first imaging unit and the second imaging unit based on the calculated installation distance of the chart and the first parallax calculated by the first parallax calculator, and corrects the parallax deviation between the first imaging unit and the second imaging unit based on the calculated parallax deviation amount.

5. The imaging device according to claim 1,
wherein the first parallax calculator uses the image of the first pattern captured by the first imaging unit as a standard image and the image of the first pattern captured by the second imaging unit as a reference image to calculate the first parallax by template matching.

6. The imaging device according to claim 1,
wherein when the first pattern and the second pattern have a same pattern,
the second parallax calculator uses the image of the first pattern captured by the first imaging unit as a standard image and the image of the second pattern captured by the second imaging unit as a reference image to calculate the second parallax by template matching.

7. The imaging device according to claim 1,
wherein when the first pattern and the second pattern have different patterns,
the second parallax calculator:
uses a template image of the first pattern preliminarily prepared as a standard image and the image of the first pattern captured by the first imaging unit as a reference image to detect a position of the first pattern on the image by template matching;
uses a template image of the second pattern preliminarily prepared as a standard image and the image of the second pattern captured by the second imaging unit as a reference image to detect a position of the second pattern on the image by template matching; and
calculates a difference between the detected position of the first pattern on the image and the detected position of the second pattern on the image as the second parallax.

8. A parallax deviation correction method for correcting a parallax deviation of an imaging device using a chart that is disposed at a known distance and has a first pattern and a second pattern, the method comprising:
a chart capturing step of capturing the chart using a first imaging unit and a second imaging unit disposed at a position separated by a constant distance in the imaging device;
a first parallax calculating step of calculating a first parallax based on an image of the first pattern captured by the first imaging unit and an image of the first pattern captured by the second imaging unit;
a second parallax calculating step of calculating a second parallax based on the image of the first pattern captured by the first imaging unit and an image of the second pattern captured by the second imaging unit; and
a correction step of correcting a parallax deviation between the first imaging unit and the second imaging unit based on the first parallax calculated in the first parallax calculating step and the second parallax calculated in the second parallax calculating step.

9. The parallax deviation correction method according to claim 8,
wherein the correction step includes:
an installation deviation amount calculating step of calculating an installation deviation amount of the chart based on the first parallax calculated in the first parallax calculating step, the second parallax calculated in the second parallax calculating step, and a parallax calculated based on the known distance;
an installation distance calculating step of calculating an installation distance of the chart based on the installation deviation amount of the chart calculated in the installation deviation amount calculating step and the known distance; and
a parallax deviation correcting step of correcting the parallax deviation between the first imaging unit and the second imaging unit based on the installation distance of the chart calculated in the installation distance calculating step.

10. The parallax deviation correction method according to claim 9,
wherein in the installation deviation amount calculating step, a difference between parallax deviation amounts is calculated based on the first parallax calculated in the first parallax calculating step, the second parallax calculated in the second parallax calculating step, and the parallax calculated based on the known distance, and an installation deviation amount of the chart is calculated based on a relation among the calculated difference between the parallax deviation amounts, the preset parallax deviation amount, and the installation deviation amount of the chart.

11. The parallax deviation correction method according to claim 9,
wherein in the parallax deviation correcting step, a parallax deviation amount between the first imaging unit and the second imaging unit is calculated based on the installation distance of the chart calculated in the installation distance calculating step and the first parallax calculated in the first parallax calculating step, and a parallax deviation between the first imaging unit and the second imaging unit is corrected based on the calculated parallax deviation amount.

12. The parallax deviation correction method according to claim 8,
wherein in the first parallax calculating step, the image of the first pattern captured by the first imaging unit is used as a standard image and the image of the first pattern captured by the second imaging unit is used as a reference image to calculate the first parallax by template matching.

13. The parallax deviation correction method according to claim 8,
wherein when the first pattern and the second pattern have a same pattern,
in the second parallax calculating step, the image of the first pattern captured by the first imaging unit is used as a standard image and the image of the second pattern captured by the second imaging unit is used as a reference image to calculate the second parallax by template matching.

14. The parallax deviation correction method according to claim 8,
wherein when the first pattern and the second pattern have different patterns,
in the second parallax calculating step,
a template image of the first pattern preliminarily prepared is used as a standard image and the image of the first pattern captured by the first imaging unit is used as a reference image to detect a position of the first pattern on the image by template matching,
a template image of the second pattern preliminarily prepared is used as a standard image and the image of the second pattern captured by the second imaging unit is used as a reference image to detect a position of the second pattern on the image by template matching, and
a difference between the detected position of the first pattern on the image and the detected position of the second pattern on the image is calculated as the second parallax.
